(19) United States
(12) Patent Application Publication
(10) Pub. No.: US 2004/0092689 A1
(43) Pub. Date: May 13, 2004

(54) Acrylic resin, adhesive comprising the resin, and optical laminate comprising the adhesive

(75) Inventors: Satoshi Yamamoto, Toyonaka-shi (JP); Tomo Iwata, Toyonaka-shi (JP); Yumiko Hashimoto, Toyonaka-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/700,639

(22) Filed: Nov. 5, 2003

(30) Foreign Application Priority Data
Nov. 6, 2002 (JP) 2002-322418

(51) Int. Cl. C08F 118/02

(52) U.S. Cl. 526/319

(57) ABSTRACT

The present invention provides An acrylic resin comprising a repeating unit derived from

(i) a methacrylate of the formula (1), (ii) a repeating unit derived from a monomer having at least two (meth)acryloyl groups of the formula (2)

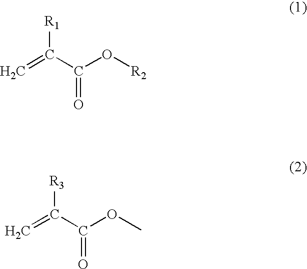

and (iii) a repeating unit derived from a monomer containing at least one polar functional group selected from the group consisting of carboxyl, hydroxyl, amide, epoxy, formyl, oxetanyl, amino and isocyanate, and containing olefinic double bond.

The present invention also provides an adhesive composition obtained by mixing (a) the acrylic resin above and (b) at least one selected from the group consisting of a hardener and a silane-based compound; an optical laminate film comprising (A) an optical film and (B) the adhesive composition layer above, and (I) the optical laminate film above and (II) a glass material layer.

### BACKGROUND OF THE INVENTION

1. Field of the Invention

The present invention relates to an acrylic resin, an adhesive comprising said resin, and an optical laminate comprising said adhesive.

2. Related Art

Liquid crystal cells generally used in liquid crystal displays such as TFT, STN and the like have a structure in which a liquid crystal component is sandwiched between two glass base materials. On the outer surface of this glass base material, optical films such as a polarizing film, phase retardation film and the like are laminated via an adhesive mainly composed of an acrylic resin.

An optical laminate sequentially laminating a glass substrate, adhesive and optical film is generally obtained by a method in which, first, an optical film with adhesive is produced by laminating an adhesive on an optical film, then, a glass base material is laminated on the surface of the adhesive.

Such an optical film with adhesive has a problem that it tends to be curled due to large change in dimension by elongation and shrinkage under heated condition or heated and humid condition, foaming occurs in an adhesive layer of the resulting optical laminate, peeling between the adhesive layer and glass base material is generated. Further, there is a problem that under heated condition or heated and humid condition, distribution of remaining stress acting on the optical film with adhesive becomes irregular, and stress concentrates on the periphery of the optical laminate, resultantly, light leakage is formed on a liquid crystal cell.

For solving such problems, adhesives obtained by mixing a plasticizer into an acrylic resin (for example, Japanese Patent Application Laid-Open (JP-A) No. 9-87593) and the like are proposed.

### SUMMARY OF THE INVENTION

An object of the present invention is to provide an acrylic resin which can relax concentration of stress caused by elongation and shrinkage of an optical film even without compounding a plasticizer, suppress light leakage of an optical laminate, suppress peeling between an optical film and an adhesive layer, and suppress foaming in an adhesive layer in an optical laminate, and which is suitable for an adhesive; an adhesive containing said acrylic resin; an optical laminate film composed of said adhesive layer and an optical film; and an optical laminate laminating glass substrate and the optical film via the adhesive layer of the optical laminate film.

The present inventors have intensively studied to solve such problems, and resultantly have completed the invention.

The present invention relates to the followings:

<1> An acrylic resin comprising a repeating unit derived from

(i) a methacrylate of the formula (1)

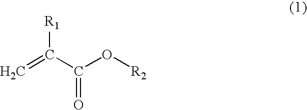

wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxyl having 1 to 10 carbon atoms,

(ii) a repeating unit derived from a monomer having at least two (meth)acryloyl groups of the formula (2)

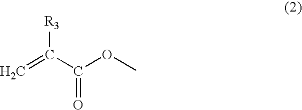

wherein R₃ represents hydrogen or methyl, and

(iii) a repeating unit derived from a monomer containing at least one polar functional group selected from the group consisting of carboxyl, hydroxyl, amide, epoxy, formyl, oxetanyl, amino and isocyanate, and-containing olefinic double bond.

<2> The acrylic resin according to <1> wherein the resin is obtained by copolymerising the methacrylate of the formula (1); the monomer having at least two (meth)acryloyl groups of the formula (2); and the monomer containing at least one polar functional group selected from the group consisting of carboxyl, hydroxyl, amide, epoxy, formyl, oxetanyl, amino and isocyanate, and containing olefinic double bond.

<3> The acrylic resin according to <1> or <2> wherein the monomer having at least two (meth)acryloyl groups of the formula (2) is (meth)acrylates of polyalcohol.

<4> An adhesive composition obtained by mixing

(a) an acrylic resin comprising

(i) a repeating unit derived from a methacrylate of the formula (1)

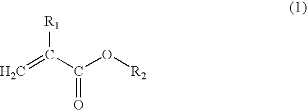

wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxyl having 1 to 10 carbon atoms,

(ii) a repeating unit derived from a monomer having at least two (meth)acryloyl groups of the formula (2)

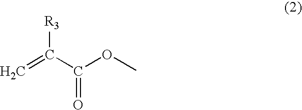

wherein R₃ represents hydrogen or methyl, and

(iii) a repeating unit derived from a monomer containing at least one polar functional group selected from the group consisting of carboxyl, hydroxyl, amide, epoxy, formyl, oxetanyl, amino and isocyanate, and containing olefinic double bond, and

(b) at least one selected from the group consisting of a hardener and a silane-based compound.

<5> The adhesive composition according to <4> wherein the hardener is isocyanate-based compound, epoxy-based compound or metal chelate-based compound.

<6> An optical laminate film comprising

(A) an optical film and

(B) an adhehive composition layer obtained by mixing

(a) an acrylic resin comprising

(i) a repeating unit derived from a methacrylate of the formula (1)

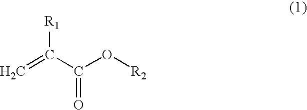

wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxyl having 1 to 10 carbon atoms,

(ii) a repeating unit derived from a monomer having at least two (meth)acryloyl groups of the formula (2)

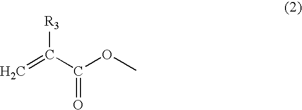

wherein R₃ represents hydrogen or methyl, and

(iii) a repeating unit derived from a monomer containing at least one polar functional group selected from the group consisting of carboxyl, hydroxyl, amide, epoxy, formyl, oxetanyl, amino and isocyanate, and containing olefinic double bond, and

(b) at least one selected from the group consisting of a hardener and a silane-based compound.

<7> The optical laminate film according to <6> wherein the optical film is at least one film selected from the group consisting of a polarizing film and phase retardation film.

<8> The optical laminate film according to <6> or <7> wherein the surface of the optical film is covered with acetylcellose based resin layer.

<9> The optical laminate film according to any one of <6> to <8> wherein the surface of the adhesive is covered with release film.

<10> An optical laminate comprising

(I) an optical laminate film comprising

(A) an optical film and

(B) an adhesive composition layer obtained by mixing

(a) an acrylic resin comprising

(i) a repeating unit derived from a methacrylate of the formula (1)

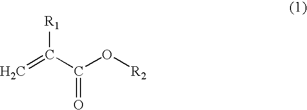

wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxyl having 1 to 10 carbon atoms,

(ii) a repeating unit derived from a monomer having at least two (meth)acryloyl groups of the formula (2)

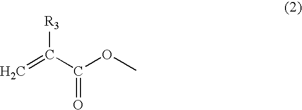

wherein R₃ represents hydrogen or methyl, and

(iii) a repeating unit derived from a monomer containing at least one polar functional group selected from the group consisting of carboxyl, hydroxyl, amide, epoxy, formyl, oxetanyl, amino and isocyanate, and containing olefinic double bond, and

(b) at least one selected from the group consisting of a hardener and a silane-based compound, and

(II) a glass material layer,

wherein the glass material layer is on the surface of the adhesive composition layer of the optical laminate film.

<11> The optical laminate according to <10> which is obtained by laminating the glass material layer on the surface of the adhesive composition layer of the optical laminate film after peeling off a release film from the optical laminate film of which the surface of the adhesive composition layer is covered with the release film.

### DETAILED DESCRIPTION OF PREFERRED EMBODIMENTS

The acrylic resin of the present invention (hereinafter referred to as “the present resin”) comprises

(i) a repeating unit derived from a methacrylate of the formula (1)

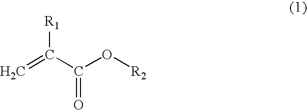

wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxyl having 1 to 10 carbon atoms,

(ii) a repeating unit derived from a monomer having at least two (meth)acryloyl groups of the formula (2)

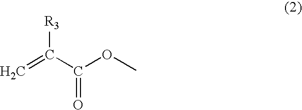

wherein R₃ represents hydrogen or methyl, and

(iii) a repeating unit derived from a monomer containing at least one polar functional group selected from the group consisting of carboxyl, hydroxyl, amide, epoxy, formyl, oxetanyl, amino and isocyanate, and containing olefinic double bond in the monomer.

The present resin can be obtained by copolymerising the methacrylate of the formula (1) (hereinafter referred to as “monomer (a)”), the monomer having at least two (meth)acryloyl groups of the formula (2) (hereinafter referred to as “monomer (b)”), and the monomer containing an olefinic double bond and at least one polar functional group selected from the group consisting of carboxyl, hydroxyl, amide, epoxy, formyl, oxetanyl, amino and isocyanate (hereinafter referred to as “monomer (c)”).

Examples of monomer (a) include acrylates such as methyl acrylate, ethyl acrylate, propyl acrylate, n-butyl acrylate, isobutyl acrylate, 2-ethylhexyl acrylate, n-octyl acrylate, isooctyl acrylate, lauryl acrylate, stearyl acrylate, cyclohexyl acrylate, benzyl acrylate, methoxyethyl acrylate, ethoxymethyl acrylate and the like; methacrylates such as methyl methacrylate, ethyl methacrylate, propyl methacrylate, n-butyl methacrylate, isobutyl methacrylate, 2-ethylhexyl methacrylate, n-octyl methacrylate, isooctyl methacrylate, lauryl methacrylate, stearyl methacrylate, cyclohexyl methacrylate, benzyl methacrylate, methoxyethyl methacrylate, ethoxymethyl methacrylate and the like.

Examples of monomer (b) include monomers having in the molecule two (meth)acryloyl groups, monomers having in the molecule three (meth)acryloyl groups, and (meth)acrylates of polyalcohols are preferred.

Specific examples thereof include monomers having in the molecule two (meth)acryloyl groups such as 1,4-butane diol di(meth)acyrlate, 1,6-hexanediol (meth)diacrylate, 1,9-nonanediol (meth)acrylate, ethylene glycol di(meth)acrylate, diethylene glycol di(meth)acrylate, tetraethylene glycol di(meth)acrylate, tripropylene glycol di(meth)acrylate and the like; monomers having in the molecule three (meth)acryloyl groups such as trimethylolpropane tri(meth)acrylate and the like.

As monomer (b), two or more of the monomers may be used.

In monomers (b), monomers having in the molecule two (meth)acryloyl groups are preferred.

Monomer (c) is a monomer containing an olefinic double bond and containing at least one polar functional group selected from the group consisting of carboxyl, hydroxyl, amide, epoxy, formyl, oxetanyl, amino and isocyanate.

Specific examples of the monomer having a carboxyl include acrylic acid, methacrylic acid, maleic acid, itaconic acid, maleic anhydride and the like, and examples of the monomer having a hydroxyl include 2-hydroxyethyl (meth)acrylate, 2-hydroxypropyl (meth)acrylate, 4-hydroxybutyl (meth)acrylate and the like. Examples of the monomer having an amide include acrylamide, methacrylamide, N-methylolacrylamide and the like, and examples of the monomer having an epoxy include glycidyl acrylate, glycidyl methacrylate and the like. Examples of the monomer having an oxetanyl include oxetanyl (meth)acrylate, 3-oxetanylmethyl (meth)acrylate, (3 -methyl-3 -oxetanyl)methyl (meth)acrylate, (3 -ethyl-3 -oxetanyl)methyl (meth)acrylate and the like, and examples of the monomers having an amino include N,N-dimethylaminoethyl acrylate, allylamine and the like. Examples of the monomers having an isocyanate include 2-methacryloyloxyethyl isocyanate and the like, and examples of the monomers having an formyl include acrlyaldehyde and the like.

As monomer (c), two or more of the monomers may be used.

In monomers (c), monomers having carboxyl and monomers having a hydroxyl are suitable.

The content of a repeating unit derived from monomer (a) (hereinafter referred to as “repeating unit (a)”) in the present resin is usually from about 75 to 99.49 wt %, preferably from about 73 to 99 wt %. The content of a repeating unit derived from monomer (b) (hereinafter referred to as “repeating unit (b)”) in the present resin is usually from about 0.01 to 5 wt %, preferably from about 0.1 to 2 wt %. When the content of a repeating unit (b) is 0.01 wt % or more, the cohesive force of the resulting resin tends to increase preferably, and when 5 wt % or less, production of gel in producing the resin tends to be suppressed preferably. The content of a repeating unit derived from monomer (c) (hereinafter referred to as “repeating unit (c)”) in the present resin is usually from about 0.5 to 20 wt %, preferably from about 0.5 to 15 wt %. When the content of repeating unit (c) is 0.5 wt % or more, the cohesive force of the resulting resin tends to increase preferably, and when 20 wt % or less, peeling between a glass material layer and an adhesive composition layer tends to be suppressed preferably in the use for the optical laminate film mentioned later.

In producing the present resin, it may also be copolymerized together with a vinyl-based monomer in addition to monomers (a) to (c). Examples of the vinyl-based monomer include vinyl esters of fatty acids, acrylates containing a dialkylamino group, (meth)acrylamides containing a dialkylamino group, vinyl halides, vinylidene halides, aromatic vinyls, (meth)acrylonitrile, conjugated diene compounds and the like.

Examples of the vinyl esters of fatty acids include vinyl acetate, vinyl propionate, vinyl butyrate, vinyl 2-ethylhexanoate, vinyl laurate and the like. Examples of the (meth)acrylate containing a dialkylamino group include dimethylaminoethyl (meth)acrylate, and the like, and examples of the (meth)acrylamide containing a dialkylamino group include dimethylaminopropyl (meth)acrylamide, and the like.

Examples of the vinyl halide include vinyl chloride, vinyl bromide, and the like, examples of the vinylidene halide include vinylidene chloride, and the like, and examples of the (meth)acrylonitrile include acrylonitrile, methacrylonitrile, and the like.

The conjugated diene compound is an olefin having in the molecule a conjugated double bond, and specific examples thereof include isoprene, butadiene, chloroprene, and the like.

The aromatic vinyl compound is a compound having a vinyl group and an aromatic group, and specific examples thereof include styrene-based monomers such as styrene, methylstyrene, dimethylstyrene, trimethylstyrene, ethylstyrene, diethylstyrene, triethylstyrene, propylstyrene, butylstyrene, hexylstyrene, heptylstyrene, octylstyrene, fluorostyrene, chlorostyrene, bromostyrene, dibromostyrene, iodostyrene, nitrostyrene, acetylstyrene, methoxystyrene, divinylbenzene and the like; nitrogen-containing aromatic vinyls such as vinylpyridine, vinylcarbazole, and the like.

As the method of producing the present resin, there are listed, for example, a solution polymerization method, emulsion polymerization method, bulk polymerization method, suspension polymerization method, and the like.

In production of the present resin, a polymerization initiator is usually used. The polymerization initiator is used in an amount of about 0.001 to 5 parts by weight based on 100 parts by weight of the total weight of the monomers (a) to (c).

As the polymerization initiator, heat polymerization initiators and photo polymerization initiators are exemplified, and listed as the photo polymerization initiator are, for example, 4-(2-hydroxyethoxyphenyl) and the like. Examples of the heat polymerization initiators include azo-based compounds such as 2,2′-azobisisobutyronitrile, 2,2′-azobis(2-methylbutyronitrile), 1,1′-azobis(cyclohexane-1-carbonitrile), 2,2′-azobis(2,4-dimethylvaleronitrile), 2,2′-azobis(2,4-dimethyl-4-methoxyvaleronitrile), dimethyl-2,2′-azobis(2-methyl propionate), 4,4′-azobis(4-cyanovaleric acid), 2,2′-azobis(2-hydroxymethylpropionitrile), and the like; organic peroxides such as tert-butyl hydroperoxide, benzoyl peroxide, tert-butyl peroxybenzoate, cumene hydroperoxide, diisopropyl peroxydicarbonate, di-n-propyl peroxydicarbonate, tert-butyl peroxyneodecanoate, tert-butyl peroxypivalate, (3,5,5-trimethylhexanonyl) peroxide and the like; inorganic peroxides such as potassium persulfate, ammonium persulfate, hydrogen peroxide and the like.

Redox initiators using a heat polymerization initiator and a reducing agent can also be used as the polymerization initiator.

As the production method for the present resin, a solution polymerization method is preferable among others.

As the specific examples of the solution polymerization method, there are listed a method in which monomers (a) to (c), optionally a vinyl-based monomer different from any of the monomers (a) to (c), and an organic solvent are mixed, and under a nitrogen atmosphere, a heat polymerization initiator is added to the mixture and the mixture is stirred from about 3 to 10 hours at about 40 to 90° C., preferably about 60 to 70° C., and the like. For controlling the reaction, monomers used and a heat polymerization initiator may be added during polymerization, or may be added in the form of solution in an organic solvent.

Examples of the organic solvent include aromatic hydrocarbons such as toluene, xylene, and the like; esters such as ethyl acetate, butyl acetate, and the like; aliphatic alcohols such as n-propyl alcohol, isopropyl alcohol, and the like; ketones such as methyl ethyl ketone, methyl isobutyl ketone, and the like.

Regarding the viscosity of thus obtained the present resin, an ethyl acetate solution containing 30 wt % of an acrylic resin is prepared and the viscosity of this solution at 25° C. is usually 100 Pa.s or less, preferably 50 Pa.s or less. When the viscosity of the acrylic resin is 100 Pa.s or less, even if the dimension of an optical film changes, an adhesive composition layer obtained during this dimension change varies following the change in the use for the optical laminate film mentioned later, consequently, there occurs a preferable tendency that a difference between brightness of circumferential parts of a liquid crystal cell and brightness of the center part disappears, and light leakage are suppressed in the use for the optical laminate.

Regarding the molecular weight of the present resin, the weight-average molecular weight by a light scattering method according to gel permeation chromatography (GPC) is usually 5×10⁵ or more, preferably 2×10⁶ or more. When the weight-average molecular weight is 5×10⁵ or more, there occurs preferably a tendency that adhesive property under high temperature and high humidity increases and peeling between a glass material layer and an adhesive composition layer decreases, further, there preferably occurs a tendency that a re-working property is improved in the use for the optical laminate film.

The present resin may be used itself in, for example, an adhesive, paint, thickening agent and the like.

A composition obtained by mixing the present resin and at least one selected from the group consisting of a hardener and a silane-based compound (hereinafter referred to as “the present composition”) is suitable as an adhesive.

The hardener has in the molecule two or more functional groups capable of cross-linking with a polar functional group, and specifically, isocyanate-based compounds, epoxy-based compounds, metal chelate-based compounds, and the like are exemplified.

Examples of the isocyanate-based compound include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethyl-xylylene diisocyanate, naphthalene diisocyanate, triphenylmethane triisocyanate, polymethylene polyphenyl isocyanate and the like. Adducts obtained by reacting the above-mentioned isocyanate-based compound with a polyol such as trimethylolpropane and the like are also used as the hardener for the present composition.

Examples of the epoxy-based compound include a bisphenol A type epoxy resin, ethylene glycol glycidyl ether, polyethylene glycol diglycidyl ether, glycerine diglycidyl ether, glycerine triglycidyl ether, 1,6-hexanediol diglycidyl ether, trimethylolpropane triglycidyl ether, diglycidylaniline, N,N,N′,N′-tetraglycidyl-m-xylenediamine, 1,3-bis(N,N′-diglycidylaminomethyl)cyclohexane, and the like.

Examples of the metal chelate compound include compounds obtained by coordinating a poly-valent metal such as aluminum, iron, copper, zinc, tin, titanium, nickel, antimony, magnesium, vanadium, chromium, zirconium and the like on acetylacetone or ethyl acetoacetate, and the like.

As the hardener in the present composition, two or more hardeners may be used.

The mixing amount of the hardener for obtaining the present composition is usually about 0.005 to 5 parts by weight, preferably about 0.01 to 3 parts by weight based on 100 parts by weight of the present resin. When the amount of the hardener is 0.005 parts by weight or more, it is preferable that peeling between an optical film and the present composition layer and a re-working property tend to be improved, and when 5 parts by weight or less, it is preferable that light leakage tend to decrease since a property of the present composition layer of following dimension change of an optical film is excellent in the use of the optical laminate film or the optical laminate mentioned later.

As the silane-based compound used in the present composition, there are usually listed, for example, vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltriemthoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloxypropyltrimethoxysilane, 3-mercaptopropyltrimethoxysilane and the like.

In the present composition, two or more silane-based compounds may be used.

The mixing amount of the silane-based compound for obtaining the present composition is usually about 0.0001 to 10 parts by weight, preferably 0.01 to 5 parts by weight based on 100 parts by weight of the present resin. When the amount of the silane-based compound is 0.0001 part or more, it is preferable that close adherence between the present composition layer and a glass substrate is improved in the use of the optical laminate film or the optical laminate mentioned later. When the amount of the silane-based compound is 10 parts or less, it is preferable that bleeding out of the silane-based compound from the present composition layer tends to be suppressed and cohesive failure of the present composition layer also tends to be suppressed in the use of the optical laminate film or of the optical laminate.

The present composition can be obtained by mixing the present resin, hardener and/or silane-based compound as described above, and an organic solvent used in the production of the present resin can be added, and further, a weather-resistant stabilizer, tackifier, plasticizer, softening agent, dye, pigment, inorganic filler, hardening catalyst, and the like can be added as long as the effect of the present invention is not prevented.

Examples of hardening catalyst include amine-based compound such as hexamethylenediamine, ethylenediamine, polyethyleneimine, hexamethylenetetramine, diethylenetriamine, triethylenetetramine, isophoronediamine, triethylenediamine, polyamino resins, melamine resins, and the like, when hardener is isocyanate-based compound.

The optical laminate film comprises (A) an optical film and (B) the present composition layer (hereinafter referred to as “the present film”).

The present film can be obtained, for example, by a method applying the present composition on a release film, evaporating an organic solvent by heating at usually from 60 to 120 for 0.5 to 10 minutes if the organic solvent is contained to obtain the present composition layer, then pasting the present composition layer with an optical film, aging for 5 to 20 days at 23 to 40° C. and relative humidity of 50%; a method obtaining the present composition layer on the release film in the same manner as in the method above, piling the obtained laminates of the present composition layer and release film so as that each of the present composition layer and release film pile alternately, aging for 5 to 20 days at 23 to 40° C. and relative humidity of 50%, then, peeling out the top or bottom of release film, pasting the present composition layer with an optical film to obtain the present laminate film, taking out the present laminate film from next release film, repeating the series of operations until necessry number of the present laminate films are obtained; and the like.

The release film is a easy-peelable film used for producing the present composition layer, and usable for protecting films from dusts or other objects.

As the release film, there are listed, for example, those obtained by using as a base material a film made of various resins such as polyethylene terephthalate, polybutylene terephthalate, polycarbonate, polyarylate and the like and performing releasing treatment (silicone treatment and the like) on the joining plane of this base material with an adhesive layer, and the like.

The optical film used in the present film a film having an optical property, and for example, a polarizing film, phase retardation film and the like are listed.

The polarizing film is an optical film having a function of emitting polarization against incident light such as natural light and the like. Listed as the polarizing film are a linearly polarizing film having a property of absorbing linearly polarization of a plane of vibration parallel to an optical axis and allowing permeation of linearly polarization having a plane of vibration which is a vertical plane, a polarization separation film reflecting linearly polarization of a plane of vibration parallel to an optical axis, an elliptical polarizing film laminating a polarizing film with a phase retardation film described later, and the like.

Specific examples of the polarizing film include those in which a dichromatic coloring matter such as iodine, dichromatic dye and the like is adsorbed and oriented on a mono-axially stretched polyvinyl alcohol film, and the like.

The phase retardation film is a mono-axial or bi-axial optically anisotropic optical film, and examples thereof include stretched films obtained by stretching a polymer film made of polyvinyl alcohol, polycarbonate, polyester, polyarylate, polyimide, polyolefin, polystyrene, polysulfone, polyether sulfone, polyvinylidene fluoride/polymethyl methacrylate, liquid crystal polyester, acetylcellulose, cyclic polyolefin, ethylene-vinyl acetate copolymer-saponified substance, polyvinyl chloride or the like at a magnification of about 1.01 to 6, and the like. Among them, polymer films obtained by mono-axial stretching or bi-axial stretching of a polycarbonate or polyvinyl alcohol are preferable.

As the phase retardation film, there are listed a mono-axial phase retardation film, wide view range phase retardation film, low photoelasticity phase retardation film, temperature adjusting type phase retardation film, LC film (rod liquid crystal twisted orientation), WV film (disk liquid crystal inclined orientation), NH film (rod liquid crystal inclined orientation), VAC film (complete bi-axial orientation type phase retardation film), new VAC film (bi-axial orientation type phase retardation film), ad the like.

The present film may further comprises protective film (base film) on the surface of the optical film. The protective film is laminated on the opposite side to the present composition layer.

As the protective film, there are listed, for example, films made of acrylic resins different from the present resin, acetylcellulose-based films such as a cellulose triacetate film and the like, polyester resin films, olefin resin films, polycarbonate resin films, polyether ether ketone resin films, polysulfone resin films and the like. In the protective film, ultraviolet absorbers such as salicylate-based compounds, benzophenone-based compounds, benzotriazole-based compounds, triazine-based compounds, cyano acrylate-based compounds, nickel complex salt-based compounds and the like may also be contained. Among the protective films, acetylcellulose-based films are suitable.

The optical laminate of the present invention comprises the present invention and a glass material layer (hereinafter referred to as “the present laminate”).

The present laminate can be obtained by laminating a glass material in the form of layer on the present composition layer of the present film. Here, as the glass material, there are listed, for example, liquid cell glass substrates, non-glaring glass, glass for sunglass and the like.

Among them, the present laminate comprising optical film(upper optical film), the present composition layer, upper glass substrate of liquid crystal cell, another optical film (lower optical film), the present composition layer and glass glass substrate of liquid crystal cell, which are laminated this order, is preferable since it can be used as a liquid display. The preferred embodiment can be obtained by laminating the present film (upper polarizing plate) on a upper glass substrate of a liquid crystal cell and laminating another present composition (lower polarizing plate) on a lower glass substrate of a liquid crystal cell.

Examples of the glass material include a soda lime glass, low alkali glass, non-alkali glass and the like.

When the present laminate film once laminated is peeled from a glass material layer of the present laminate, paste remaining and fogging on the surface of the glass substrate can be suppressed, which means that the present laminate is excellent in re-work property.

The present invention will be illustrated further specifically with examples. In the examples, “parts” and “%” are by weight unless otherwise stated. The viscosity is a value measured by a Brookfield viscometer at 25° C. For measurement of the weight-average molecule weight by a light scattering method of GPC, a GPC apparatus equipped with a light scattering photometer and a differential refractometer as a detector was used, and tetrahydrofuran was used as eluent, under conditions of a sample concentration of 5 mg/ml, a sample introduction amount of 100 μl, a column temperature of 40° C. and a flow rate of 1 ml/min.

### EXAMPLE 1

### Acrylic Resin Production Example

A mixed solution of 95 parts of butyl acrylate as monomer (a), 4 parts of 4-hydroxybutyl acrylate as monomer (b) and 0.2 part of ethylene glycol diacrylate as monomer (c) was prepared. Separately, into a reactor equipped with a cooling tube, nitrogen introducing tube, thermometer and stirrer was charged 233 parts ethyl acetate, air in the apparatus was purged with a nitrogen gas, then, the inner temperature was raised to 70° C. 0.05 part of azobisisobutyronitrile (hereinafter, referred to as AIBN) was added to the reactor, then, the mixed solution above was dropped into the reactor over 3 hours while maintaining the inner temperature at 65 to 75° C. Then, the mixture was kept at 70° C. for 5 hours, to complete the reaction. An ethyl acetate solution of an acrylic resin having a solid content of 30.5% and a weight-average molecular weight of 8200000 was obtained. The viscosity when the solid content of the solution was controlled to 30% was 4600 mPa.s.

### Adhesive Production Example

Into the ethyl acetate solution of the resulted acrylic resin was mixed a polyisocyanate-based compound (trade name: Coronate L, manufactured by Nippon Polyurethane Co., Ltd., solid content: 0.1 part) as a hardener and a silane-based compound, γ-glycidoxypropyltrimethoxysilane (solid content: 0.2 parts).

### Production Example of Optical Film with Adhesive

Thus obtained adhesive was applied on a polyethylene terephthalate release film (manufactured by Linteck Corporation, trade name: PET 3801), then, dried. In this operation, the adhesive layer after drying was controlled to have a thickness of 25 μm. Then, a polarizing film of 180 μm (a three-layer film obtained by placing a triacetylcellulose-based protective film on both surfaces of a film prepared by allowing polyvinyl alcohol to adsorb iodine and stretching this) was used as an optical film, and on this optical film, the adhesive layer was laminated from the resulted release film by a laminator, then, the laminate was aged for 14 days under conditions of a temperature of 40° C. and a humidity of 50%, to obtain an optical film with adhesive.

### Optical Laminate Production Example

The adhesive layer of the optical film with adhesive obtained above was laminated on both surfaces of a glass substrate for liquid crystal cell (manufactured by Nippon Sheet Glass Co., Ltd., soda lime glass) so as to give crossed Nicols, obtaining an optical laminate. This was stored at 80° C. for 500 hours in dry condition (condition 1) or stored at 60° C. and 90% RH for 500 hours (condition 2). Then, conditions of manifestation of light leakage and durability of the optical laminate after respective storages were visually observed. The results are classified as described below and summarized in Table 1-1.

### Durability

Evaluation of durability was conducted based on the following 4 stages.

⊚: Changes in appearances such as float, peeling, foaming and the like are not observed at all.

◯: Changes in appearances such as float, peeling, foaming and the like are scarcely observed.

Δ: Changes in appearances such as float, peeling, foaming and the like are somewhat noticeable.

×: Changes in appearances such as float, peeling, foaming and the like are remarkably recognized.

### Light Leakage Manifestation Condition

The condition of manifestation of light leakage was evaluated based on the following 4 stages.

⊚: Light leakage is not observed at all.

◯: Light leakage is scarcely noticeable.

Δ: Light leakage is somewhat noticeable.

×: Light leakage is remarkably recognized.

### Re-Working Property

Evaluation of a re-working property was conducted as follows.

First, the above-mentioned optical film with adhesive was cut into specimens of 25 mm×150 mm. Next, this specimen was laminated on a glass substrate for liquid crystal cell (manufactured by Nippon Sheet Glass Co., Ltd., soda lime glass) using a pasting apparatus (manufactured by Fuji Plastic Machine K. K., Lamipacker), and the laminate was subjected to autoclave treatment at 50° C. and 5 kg/cm² (490.3 kPa) for 20 minutes, to obtain an optical laminate for peeling test. Subsequently, this optical laminate for peeling test was stored in an atmosphere of 23° C. and 50% RH for 720 hours, and this pasted specimen was peeled toward 180° direction at a speed of 300 mm/min in an atmosphere of 23° C. and 50% RH, and the condition of the surface of the resulted glass plate was observed. The results are classified as described below and summarized in Table 1-1.

Evaluation of a re-working property was conducted based on the following 4 stages depending on the condition of the surface of a glass plate.

⊚: Fogging and paste remaining are not observed at all on the surface of a glass plate.

◯: Fogging and the like are scarcely observed but paste remaining is not obserbed on the surface of a glass plate.

Δ: Fogging and the like are observed but paste remaining is not obserbed on the surface of a glass plate.

×: Paste remaining is observed on the surface of a glass plate.

### EXAMPLES 2 to 3, COMPARATIVE EXAMPLES 1 to 2

In Examples 2 to 3, acrylic resins, adhesives and optical laminates were produced in the same manner as in Example 1 except that the amount of AIBN was changed to the amount described in Table 1-1. The results of evaluation of the resulted acrylic resin and optical laminate are summarized in Table 1-1.

In Comparative Example 1, an acrylic resin, adhesive and optical laminate were produced in the same manner as in Example 1 except that the monomer (c) was not used and the amount of AIBN was changed to the amount described in Table 1-2. The results of evaluation of the resulted acrylic resin and optical laminate are summarized in Table 1-2.

In Comparative Example 2, an acrylic resin, adhesive and optical laminate were produced in the same manner as in Example 1 except that the monomer (c) was not used and purified acrylic resin obtained by the purification steps was used. The purification steps consist of the followings: An ethyl acetate solution of an acrylic resin is added into methanol and the resulting precipitates were obtained by filtration, and then the precipitates were dissolved in ethyl acetate to give again an ethyl acetate solution of an acrylic resin.

The results of evaluation of the resulted acrylic resin and optical laminate are summarized in Table 1-2.

TABLE 1-1

| | | Example 1 | Example 2 | Example 3 |
|---|---|---|---|---|
| Production of | (a) | 95 | 95 | 95 |
| acrylic resin | (b) | 4 | 4 | 4 |
| (part) | (c) | 0.2 | 0.2 | 0.2 |
| | AIBN | 0.05 | 0.09 | 0.04 |
| Acrylic resin | Viscosity | 4,600 | 1,700 | 9,900 |
| | (mPa · s) | | | |
| | Molecular | 8,200 | 3,500 | Measurement |
| | weight (×1000) | | | impossible |
| Condition | Durability | ⊚ | ⊚ | ⊚ |
| 1 | Light leakage | ⊚ | ⊚ | ◯ |
| | property | | | |
| Condition | Durability | ⊚ | ◯ | ⊚ |
| 2 | Light leakage | ⊚ | ⊚ | ⊚ |
| | property | | | |
| Re-working | Paste emaining | ⊚ | ◯ | ⊚ |
| property | property | | | |

TABLE 1-2

| | | Comparative | Comparative |
|---|---|---|---|
| | | Example 1 | Example 2 |
| Production of | (a) | 95 | 95 |
| acrylic resin | (b) | 4 | 4 |
| (part) | (c) | 0 | 0 |
| | AIBN | 0.01 | 0.05 |
| Acrylic resin | Viscosity | 5,800 | 513,000 |
| | (mPa · s) | | |
| | Molecular | 900 | 7,800 |
| | weight | | |
| | (×1000) | | |
| Condition | Durability | Δ | Δ |
| 1 | Light leakage | ⊚ | X |
| | property | | |
| Condition | Durability | X | ⊚ |
| 2 | Light leakage | ⊚ | X |
| | property | | |
| Re-working | Paste remaining | X | ⊚ |
| property | property | | |

The acrylic resin of the present invention is excellent in softness and shows excellent close adhesion to an optical film and the like. An adhesive composition of the present invention is suitable as an adhesive.

An optical laminate film of the present invention gives the optical laminate of the present invention, when laminated on, for example, a glass substrate of a liquid crystal cell.

With such the optical laminate of the present invention, local concentration of stress can be decreased and peeling between the glass material layer and the the adhesive composition layer can be suppressed, since the adhesive composition layer absorbs and relaxes stress caused by change in dimension of an optical film under humid heat condition. Further, since optical failures caused by irregular stress distribution can be prevented, light leakage can be suppressed when the glass material layer is a liquid crystal cell.

Furthermore, due to an excellent re-working property, when an optical laminate film once laminated is peeled from a glass substrate of an optical laminate, paste remaining and fogging on the surface of the glass substrate can be suppressed.

What is claimed is:

1. An acrylic resin comprising a repeating unit derived from
(i) a methacrylate of the formula (1) 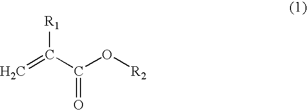
wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxyl having 1 to 10 carbon atoms,
(ii) a repeating unit derived from a monomer having at least two (meth)acryloyl groups of the formula (2) 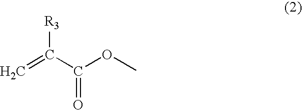
wherein R₃ represents hydrogen or methyl, and
(iii) a repeating unit derived from a monomer containing at least one polar functional group selected from the group consisting of carboxyl, hydroxyl, amide, epoxy, formyl, oxetany, aminol and isocyanate, and containing olefinic double bond.

2. The acrylic resin according to claim 1 wherein the resin is obtained by copolymerising the methacrylate of the formula (1); the monomer having at least two (meth)acryloyl groups of the formula (2); and the monomer containing at least one polar functional group selected from the group consisting of carboxyl, hydroxyl, amide, epoxy, formyl, oxetanyl, amino and isocyanate, and containing olefinic double bond.

3. The acrylic resin according to claim 1 wherein the monomer having at least two (meth)acryloyl groups of the formula (2) is (meth)acrylates of polyalcohol.

4. An adhesive composition obtained by mixing
(a) an acrylic resin comprising
(i) a repeating unit derived from a methacrylate of the formula (1) 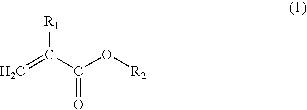
wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxyl having 1 to 10 carbon atoms,
(ii) a repeating unit derived from a monomer having at least two (meth)acryloyl groups of the formula (2) 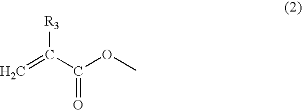
wherein R₃ represents hydrogen or methyl, and
(iii) a repeating unit derived from a monomer containing at least one polar functional group selected from the group consisting of carboxyl, hydroxyl, amide, epoxy, formyl, oxetanyl, amino and isocyanate, and containing olefinic double bond, and
(b) at least one selected from the group consisting of a hardener and a silane-based compound.

5. The adhesive composition according to claim 4 wherein the hardener is isocyanate-based compound, epoxy-based compound or metal chelate-based compound.

6. An optical laminate film comprising
(A) an optical film and
(B) an adhehive composition layer obtained by mixing
(a) an acrylic resin comprising
(i) a repeating unit derived from a methacrylate of the formula (1) 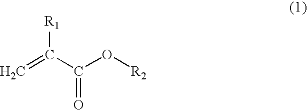
wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxyl having 1 to 10 carbon atoms,
(ii) a repeating unit derived from a monomer having at least two (meth)acryloyl groups of the formula (2) 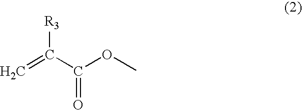
wherein R₃ represents hydrogen or methyl, and
(iii) a repeating unit derived from a monomer containing at least one polar functional group selected from the group consisting of carboxyl, hydroxyl, amide, epoxy, formyl, oxetanyl, amino and isocyanate, and containing olefinic double bond, and
(b) at least one selected from the group consisting of a hardener and a silane-based compound.

7. The optical laminate film according to claim 6 wherein the optical film is at least one film selected from the group consisting of a polarizing film and phase retardation film.

8. The optical laminate film according to claim 6 wherein the surface of the optical film is covered with acetylcellose based resin layer.

9. The optical laminate film according to claim 6 wherein the surface of the adhesive is covered with release film.

10. An optical laminate comprising
(I) an optical laminate film comprising
(A) an optical film and
(B) an adhesive composition layer obtained by mixing
(a) an acrylic resin comprising
(i) a repeating unit derived from a methacrylate of the formula (1) 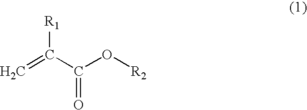
wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxyl having 1 to 10 carbon atoms,
(ii) a repeating unit derived from a monomer having at least two (meth)acryloyl groups of the formula (2) 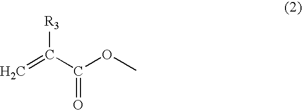
wherein R₃ represents hydrogen or methyl, and
(iii) a repeating unit derived from a monomer containing at least one polar functional group selected from the group consisting of carboxyl, hydroxyl, amide, epoxy, formyl, oxetanyl, amino and isocyanate, and containing olefinic double bond, and
(b) at least one selected from the group consisting of a hardener and a silane-based compound, and
(II) a glass material layer,
wherein the glass material layer is on the surface of the adhesive composition layer of the optical laminate film.

11. The optical laminate according to claim 10 which is obtained by laminating the glass material layer on the surface of the adhesive composition layer of the optical laminate film after peeling off a release film from the optical laminate film of which the surface of the adhesive composition layer is covered with the release film.
